(19) United States
(12) Patent Application Publication
(10) Pub. No.: US 2018/0226801 A1
(43) Pub. Date: Aug. 9, 2018

(54) Determining an Operating Strategy for a Local Storage Device

(71) Applicant: Bayerische Motoren Werke Aktiengesellschaft, Muenchen (DE)

(72) Inventors: Michael BEER, Muenchen (DE); Caglayan ERDEM, Augsburg (DE); Willibald PRESTL, Eichenau (DE)

(21) Appl. No.: 15/945,423

(22) Filed: Apr. 4, 2018

Related U.S. Application Data
(63) Continuation of application No. PCT/EP2016/069815, filed on Aug. 22, 2016.

(30) Foreign Application Priority Data
Oct. 5, 2015 (DE) 10 2015 219 201.6

(51) Int. Cl. H02J 3/28; H02J 7/00; G06Q 10/06; G06Q 50/06

(52) U.S. Cl. CPC H02J 3/28; H02J 7/0068; G06Q 50/06; G06Q 10/0637; G06Q 10/06315

(57) ABSTRACT

A method for determining an operating strategy for an electrical energy store includes subdividing an operating time interval, for which the operating strategy of the energy store is intended to be determined, into a sequence of time segments such that constant power conditions are respectively present in the time segments in the sequence of time segments. For each time segment in the sequence of time segments, a limited number of possible operating powers with which the energy store can be charged and/or discharged in the respective time segment are determined. A plurality of sequences of operating points are determined, where each of the operating points indicates an operating power from the limited number of possible operating powers for a given time segment from the sequence of time segments, and where each sequence of operating points from the plurality of sequences of operating points indicates a sequence of operating powers for the sequence of time segments. A sequence of operating points from the plurality of sequences of operating points is then selected as the operating strategy.

### CROSS REFERENCE TO RELATED APPLICATIONS

This application is a continuation of PCT International Application No. PCT/EP2016/069815, filed Aug. 22, 2016, which claims priority under 35 U.S.C. § 119 from German Patent Application No. 10 2015 219 201.6, filed Oct. 5, 2015, the entire disclosures of which are herein expressly incorporated by reference.

### BACKGROUND AND SUMMARY OF THE INVENTION

The invention relates to a method and a corresponding control unit for determining an operating strategy, in particular for determining a charging/discharging plan, for a local storage device in a household.

A household may comprise a multiplicity of electrical consumers and one or more sources/generators of electrical energy (for example a solar installation and/or an electrical home connection to a supply network). The household may also comprise one or more electrical energy stores which appear as a consumer when they are being charged and appear as a source when they are being discharged. These various components of a household can be centrally controlled via an HEMS (Home Energy Management System) in order to optimize the electrical energy consumption according to particular criteria (for example in order to minimize the costs of electrical energy).

The present document deals with the technical object of efficiently determining an operating strategy (in particular a charging/discharging plan) for an energy store in a household, which reduces (in particular minimizes) a predefined cost criterion.

One aspect describes a method for determining an operating strategy for an electrical energy store (in particular for a local storage device of a household). In this case, the electrical energy store can sometimes be charged and can sometimes be discharged within the scope of the operating strategy. It is therefore possible to determine an operating strategy having one or more charging time segments and one or more discharging time segments. The method comprises subdividing an operating time interval, for which the operating strategy is intended to be determined, into a sequence of time segments. In this case, the subdivision is preferably carried out in such a manner that constant power conditions are respectively present in the time segments in the sequence of time segments. The power conditions may comprise a maximum charging power which can be received by the energy store at a particular time and/or a maximum discharging power which can be provided by the energy store at a particular time. Alternatively or additionally, the power conditions may comprise (positive or negative) energy costs which arise (typically as positive costs) at a particular time for charging the energy store and/or which arise (typically as negative costs) at a particular time when discharging the energy store. Alternatively or additionally, the power conditions may a power which is requested by one or more electrical consumers of a household and is predicted for a particular time and/or a locally generated power which is predicted for a particular time and can be provided by a local energy generation unit, in particular by a solar installation.

The method also comprises determining, for each time segment in the sequence of time segments, a limited number of possible operating powers with which the energy store can be charged and/or discharged in the respective time segment. In this case, the process of determining the limited number of possible operating powers may comprise dividing an operating power interval into N possible operating powers, where N may be less than or equal to 10 (for example 5). N may possibly also assume values above 10. The operating power interval may have an upper limit defined by a maximum charging power which can be received at most by the energy store (for example as a result of a technical limitation). Furthermore, the operating power interval may have a lower limit defined by a maximum discharging power which can be provided at most by the energy store (for example as a result of a technical limitation).

A limited number of possible operating powers can therefore be respectively defined for a limited number of time segments. It is thus possible to define a network having a limited number of operating points for a limited number of time segments. In this case, an operating point for a time segment indicates an operating power from the limited number of possible (positive or negative) operating powers for this time segment. The problem of determining an (optimum) operating strategy (that is to say an optimum charging/discharging plan) can therefore be formulated as the problem of determining an (optimum) path through the network of operating points (that is to say a sequence of operating points).

The method also comprises determining a multiplicity of sequences of operating points. In this case, a sequence of operating points indicates a sequence of operating powers for the corresponding sequence of time segments. In other words, a sequence of operating points indicates the (constant) operating powers with which the energy store is intended to be charged and/or discharged in the various time segments in the sequence of time segments. In this case, the multiplicity of sequences of operating points can be determined in a particularly efficient and precise manner by means of dynamic programming, in particular by means of a Viterbi algorithm. A sequence of operating points can then be selected from the multiplicity of sequences of operating points as the operating strategy for the energy store.

The above-mentioned method, in particular the temporal division into time segments and/or the division into a limited number of possible operating powers, makes it possible to efficiently determine cost-optimized operating strategies. In this case, predicted information with regard to the power requested by consumers, with regard to the locally generated power and/or with regard to the energy costs of externally obtained electrical energy can be taken into account when determining the operating strategy. Cyclization of the local energy store can thus be reduced, in particular.

An operating point for a time segment can indicate (positive or negative) costs which are caused by the charging and/or discharging with the (positive or negative) operating power indicated by the operating point. These costs can be determined, for example, on the basis of the energy costs in the time segment and on the basis of the operating power of the operating point. In this case, the costs may depend, in particular, on whether the operating power is (at least partially) provided by a local energy generator, whether the operating power is (at least partially) obtained from a public network or is fed into a public network (and under what conditions), etc.

The process of determining a multiplicity of sequences of operating points may comprise determining, on the basis of the costs indicated by the operating points, a multiplicity of cumulative costs for the corresponding multiplicity of sequences of operating points. The sequence of operating points for the operating strategy can then be selected on the basis of the multiplicity of cumulative costs. It is therefore possible to select an operating strategy which minimizes the cumulative costs.

The multiplicity of sequences of operating points can be determined iteratively, time segment by time segment, starting from a starting time segment and/or starting from an end time segment in the sequence of time segments. In particular, the process of determining a multiplicity of sequences of operating points may comprise: for a first time segment in the sequence of time segments, determining M subsequences of operating points running from the starting time segment or from the end time segment to a second time segment which adjoins the first time segment. In this case, M may be, for example, 20, 10 or less. On the basis of the operating points for the first time segment and on the basis of the M subsequences of operating points, it is then possible to determine extended subsequences of operating points which run from the starting time segment or from the end time segment to the first time segment. The multiplicity of sequences of operating points can therefore be determined iteratively, time segment by time segment. The computational effort for determining the multiplicity of sequences of operating points can be limited as a result of the limitation to a limited number M of subsequences of operating points.

The process of determining a multiplicity of sequences of operating points may comprise: determining M cumulative partial costs for the M subsequences of operating points for the first time segment in the sequence of time segments. On the basis of the operating points for the first time segment and on the basis of the M cumulative partial costs, it is then possible to determine cumulative partial costs for the extended subsequences of operating points. Furthermore, a subset of the extended subsequences of operating points (for example M extended subsequences of operating points) can be selected on the basis of the cumulative partial costs for the extended subsequences of operating points. In particular, a limited subset having the lowest cumulative partial costs can be selected. A cost-optimized operating strategy can therefore still be provided with limited computational effort.

The method may also comprise determining transition costs for a transition from an operating point in the second time segment to an operating point in the first time segment. In this case, the transition costs may depend, in particular, on costs of changing the operating power (as a result of the transition between the operating points). The cumulative partial costs for the extended subsequences of operating points can then also be determined on the basis of the transition costs. Costs which are caused by changing the operating power can thus be efficiently taken into account.

The method may also comprise checking whether a first extended subsequence of operating points satisfies a secondary condition, in particular with respect to an amount of energy provided overall by the extended subsequence of operating points. The first extended subsequence of operating points can be rejected if the secondary condition has not been satisfied. Operating strategies which do not satisfy the required secondary conditions (for example a required SOC (State of Charge) of the energy store at a particular time) can therefore be rejected at an early time. The computational effort can therefore be reduced further.

Another aspect describes a control unit (for an HEMS) which is set up to carry out the above-mentioned method.

Another aspect describes a software (SW) program. The SW program can be set up to be executed on a processor and to thereby carry out the method described in this document.

Another aspect describes a storage medium. The storage medium may comprise an SW program which is set up to be executed on a processor and to thereby carry out the method described in this document.

It should be noted that the methods, apparatuses and systems described in this document can be used both alone and in combination with other methods, apparatuses and systems described in this document. Furthermore, any aspects of the methods, apparatuses and systems described in this document can be combined with one another in various ways. In particular, the features of the claims can be combined with one another in various ways.

Other objects, advantages and novel features of the present invention will become apparent from the following detailed description of one or more preferred embodiments when considered in conjunction with the accompanying drawings.

### BRIEF DESCRIPTION OF THE DRAWINGS

The invention is described in more detail below on the basis of exemplary embodiments. In this case

FIG. 1 shows a block diagram of an exemplary system for charging/discharging a local storage device.

FIG. 2a shows exemplary temporal profiles for the consumption of a household, for the energy costs of externally obtained electrical energy and for the amount of locally generated electrical energy.

FIG. 2b shows an exemplary division of an operating time interval into time segments and exemplary possible charging/discharging powers (that is to say operating powers).

FIG. 3 shows exemplary sequences of operating points.

FIG. 4 shows a flowchart of an exemplary method for determining an operating strategy.

### DETAILED DESCRIPTION OF THE DRAWINGS

As explained at the outset, the present document deals with the determination of an operating strategy (in particular a charging/discharging plan) for a local storage device. FIG. 1 shows a block diagram for a system 100 for operating a local electrical energy store 111 (also referred to as local storage device). The local storage device 111 can be charged with electrical energy from an external supply network 104. The local storage device 111 can also be charged with electrical energy from a local energy generation unit 103, for example from a solar installation. On the other hand, the local storage device 111 can deliver electrical energy to one or more electrical consumers 102. The system 100 comprises a control unit 101 which is set up to control a charging/discharging operation of the energy store 111. In particular, the control unit 101 is set up to determine an operating strategy for charging and/or discharging the energy store 111 and to charge and/or discharge the energy store 111 on the basis of the operating strategy.

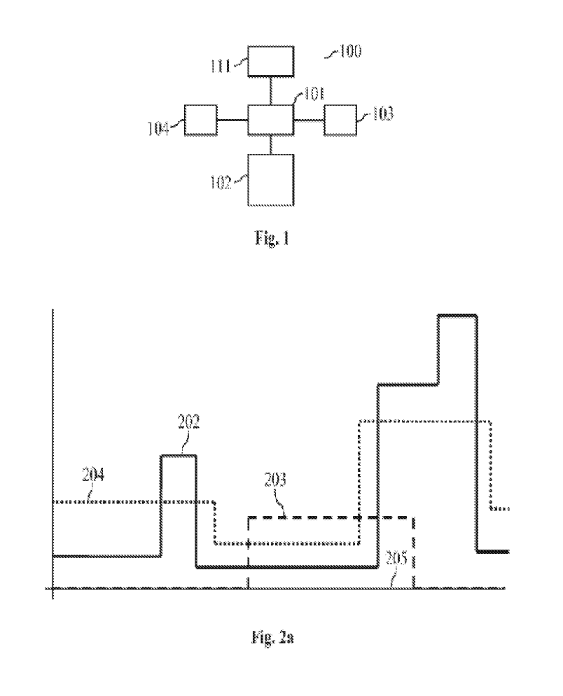

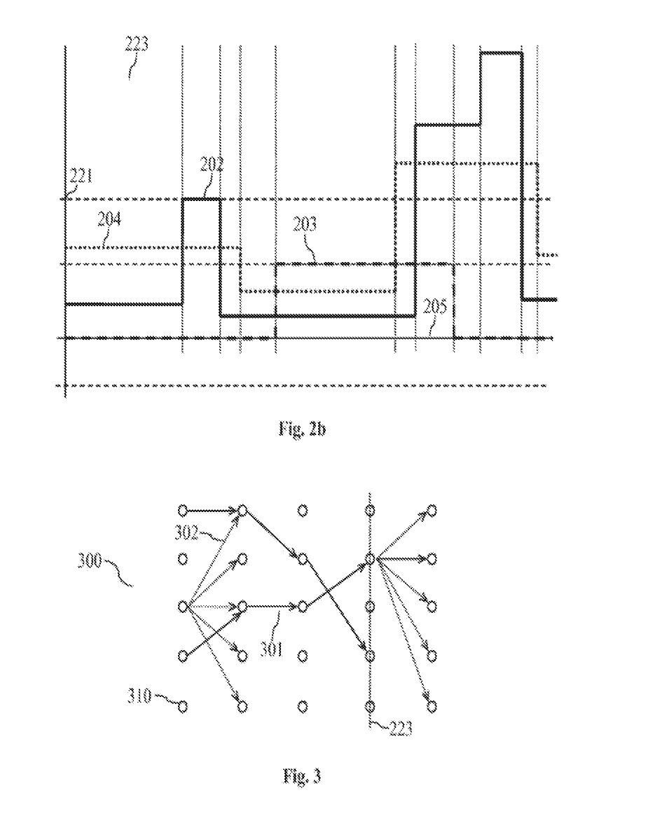

Different maximum operating powers are typically available at different times for charging the energy store 111. The maximum operating power available for charging may vary, for example, on account of the temporal availability of energy sources 103, 104 (for example solar energy) and/or on account of the different demand for electrical energy from different electrical consumers 102. FIG. 2a shows an exemplary (predicted) profile of the locally generated power 203 which can be provided by a local energy generation unit 103 over time 205. For example, electrical power 203 can be provided by a solar installation 103 only during the day. FIG. 2a also shows an exemplary (predicted) profile of the requested power 202 requested by the electrical consumers 102 in a household over time 205.

FIG. 2a also shows an exemplary profile of the energy costs 204 over time 205. The energy costs 204 may vary, for example, on account of the different composition of the available electrical energy. For example, the energy costs 204 may be lower if solar energy is available than if the electrical energy is obtained via a public supply network. Alternatively or additionally, the energy costs 204 may depend on a cost structure for externally obtained electrical energy.

The intention is now to determine an operating strategy for the energy store 111, which ensures that the cumulative costs are reduced (in particular minimized) over an operating period (for example over one day). In this case, the cumulative costs may comprise the costs of obtaining electrical energy from an external supplier 104, the costs of (high) cyclization of the energy store 111, the costs of (possibly reduced) autonomy of the household and/or the costs of (possible) losses of comfort. It is therefore possible to determine an operating strategy which reduces (in particular minimizes) a predefined cost function, the cost function being able to depend on one or more of the above-mentioned criteria.

For this purpose, a sequence of time segments in which the power conditions are substantially constant can be determined for the operating time interval (for example a period of 24 hours). Exemplary power conditions are the available locally generated power 203, the power 202 requested by the consumers 102 of the household and/or the above-mentioned energy costs 204 in a particular time segment. In particular, it is therefore possible to determine a sequence of time segments in which the locally generated power 203, the requested power 202 and the energy costs 204 are (substantially) constant. For this purpose, the profile of the locally generated power 203, the profile of the requested power 202 and the profile of the energy costs 204 can be used to determine times at which at least one power condition changes. These times can be considered to be boundaries between adjacent time segments.

FIG. 2b shows exemplary time segments 223 for the profiles from FIG. 2a. The power conditions are constant within a time segment 223. These time segments 223 can be used as the temporal resolution for determining a cost-optimal operating strategy. The complexity of the optimization problem for determining an operating strategy can therefore be reduced.

The operating time interval can therefore be subdivided into a sequence of time segments 223, the power conditions being (substantially) constant in each time segment 223. For each time segment 223, it is also possible to define different possible operating powers 221 with which the energy store 111 can be charged and/or discharged in the respective time segment 223. Four different operating powers 221 between a minimum possible operating power and a maximum possible operating power (for example −5 kW, 0 kW, 5 kW and 7 kW) are defined in FIG. 2b. The maximum possible operating power (for discharging) and the maximum possible operating power (for charging) of the energy store 111 may depend on properties of the energy store 111.

The energy store 111 can therefore be charged and/or discharged with different operating powers 221 in a time segment 223. For each time segment 223, it is therefore possible to define different amounts of energy which can be supplied to or removed from the energy store 111 in the respective time segment 223. In this case, the amounts of energy result from the operating power 221 and from the temporal length of a time segment 223.

FIG. 3 shows a network 300 of operating points 310. The network 300 comprises a multiplicity of operating points 310 for a time segment 223, an operating point 310 having one or more operating point parameters. The operating point parameters may comprise:

the amount of energy transmitted to the energy store 111 or removed from the energy store 111 in the time segment 223 of the operating point 310;

the operating power 221 with which charging and/or discharging is carried out in the time segment 223 of the operating point 310; and/or

the costs associated with the transmitted amount of energy.

The network 300 also comprises transitions 302 (illustrated by means of dotted or solid arrows) from a first operating point 310 (in a first time segment 223) to a second operating point 310 (in a second time segment 223 directly following the first time). The transitions 302 may comprise one or more transition parameters. The transition parameters may comprise, for example, costs of changing the operating power.

It is therefore possible to provide a network 300 which defines possible operating powers for a charging/discharging operation and associated costs. A path 301, that is to say a temporal sequence of operating points 310, through the network 300 can then be found, which path reduces (possibly minimizes) a predefined cost criterion comprising, for example, the cumulative energy costs in the operating time interval. The path 301 is illustrated by means of the solid arrows in FIG. 3. In this case, a dynamic programming method, in particular a Viterbi algorithm, can be efficiently used.

In particular, starting from the operating points 310 for a starting time segment 223 in the sequence of time segments 223 for example, a path 310 of operating points 310 to an end time segment 223 in the sequence of time segments 223 can be iteratively determined. In order to reduce the computational effort, a limited number of partial paths can be selected in this case in each iteration step (that is to say for each time segment 223 in the sequence of time segments 223). Only the limited number of partial paths is then taken into account for the further method. Furthermore, paths which do not satisfy a predefined secondary condition can be excluded at an early time (for example paths which do not reach or exceed the total amount of energy to be received by the energy store 111 during the operating time interval).

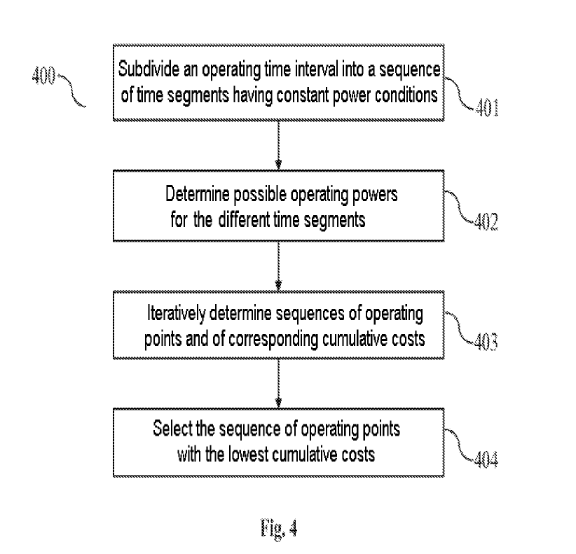

FIG. 4 shows a flowchart of an exemplary method 400 for determining an operating strategy for an electrical energy store 111. The energy store 111 may comprise a local energy store in a household. Alternatively or additionally, the energy store 111 may comprise an energy store for driving an electric vehicle. The method 400 comprises subdividing 401 an operating time interval (for example a time interval of 24 hours) into a sequence of time segments 223, with the result that constant (possibly predicted) power conditions are respectively present in the time segments 223 in the sequence of time segments 223. The method 400 also comprises determining 402, for each time segment 223 in the sequence of time segments 223, a limited number of possible operating powers 221 with which the energy store 111 can be charged and/or discharged in the respective time segment 223. The method 400 also comprises determining 403 a multiplicity of sequences of operating points 310. In this case, an operating point 310 for a time segment 223 indicates an operating power from the limited number of possible operating powers for this time segment 223. A sequence of operating points 310 also indicates a sequence of operating powers for the sequence of time segments 223. The method 400 also comprises selecting 404 a sequence of operating points 310 from the multiplicity of sequences of operating points 310 as the operating strategy.

In particular, it is possible to use parameterized dynamic programming with special suitability assessment for meaningfully possible temporal combinations of operating powers in order to determine a cost-optimal operating strategy.

Predicted information with respect to the power 202 requested by consumers, with respect to the locally generated power 203 and/or with respect to the energy costs 204 of externally obtained electrical energy can be taken into account when determining the operating strategy. This information can be predicted for the future operating time interval on the basis of historical data. Additional information (for example a weather forecast) can also be used to predict the requested power 202, the locally generated power 203 and/or the energy costs 204. Time segments 223 having constant power conditions can then be determined from this predicted information. An operating strategy for an energy store can therefore be determined in a precise and efficient manner for a future operating time interval on the basis of historical data.

Cost optimization versus autonomy optimization of the energy store can be carried out by means of the described method by accordingly taking into account different cost terms. Furthermore, load management situations in a home can be avoided by means of predictive energy management. The local storage device may possibly be allocated to individual loads (for example an electric vehicle) as part of the optimization. Furthermore, the aim may be to reduce the cyclization, in particular. In addition, a local storage device may possibly be used in a group of energy stores.

In other words, the costs of the electrical energy for a household can therefore be minimized by means of the method described in this document. Furthermore, a degree of autonomy can be increased by specifically using local energy sources. The cyclization of local energy stores can also be reduced, as a result of which the service life of such energy stores can be increased. The method described in this document is scalable and can therefore be additionally used for a group of energy stores.

The present invention is not restricted to the exemplary embodiments shown. In particular, it should be noted that the description and the figures are intended to illustrate only the principle of the proposed methods, apparatuses and systems.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for determining an operating strategy for an electrical energy store, the method comprising the acts of:
subdividing an operating time interval, for which the operating strategy of the energy store is intended to be determined, into a sequence of time segments such that constant power conditions are respectively present in the time segments in the sequence of time segments;
determining, for each time segment in the sequence of time segments, a limited number of possible operating powers with which the energy store can be charged and/or discharged in the respective time segment;
determining a plurality of sequences of operating points, wherein each of the operating points indicates an operating power from the limited number of possible operating powers for a given time segment from the sequence of time segments, and wherein each sequence of operating points from the plurality of sequences of operating points indicates a sequence of operating powers for the sequence of time segments; and
selecting a sequence of operating points from the plurality of sequences of operating points as the operating strategy.

2. The method as claimed in claim 1, wherein the plurality of sequences of operating points are determined by dynamic programming.

3. The method as claimed in claim 2, wherein the plurality of sequences of operating points are determined by a Viterbi algorithm.

4. The method as claimed in claim 1,
wherein each of the operating points further indicates costs which are caused by the charging and/or discharging with the operating power indicated by the respective operating point;
wherein determining the plurality of sequences of operating points comprises determining, based on the costs indicated by the operating points, a plurality of cumulative costs for the corresponding multiplicity of sequences of operating points; and
wherein selecting the sequence of operating points for the operating strategy comprises selecting the sequence of operating points from the plurality of sequences of operating points based on the plurality of cumulative costs.

5. The method as claimed in claim 2,
wherein each of the operating points further indicates costs which are caused by the charging and/or discharging with the operating power indicated by the respective operating point;
wherein determining the plurality of sequences of operating points comprises determining, based on the costs indicated by the operating points, a plurality of cumulative costs for the corresponding multiplicity of sequences of operating points; and
wherein selecting the sequence of operating points for the operating strategy comprises selecting the sequence of operating points from the plurality of sequences of operating points based on the plurality of cumulative costs.

6. The method as claimed in claim 4, wherein determining the plurality of sequences of operating points comprising, for a first time segment in the sequence of time segments,
determining M subsequences of operating points running from a starting time segment or from an end time segment to a second time segment which adjoins the first time segment; and
determining, based on the operating points for the first time segment and on the M subsequences of operating points, extended subsequences of operating points which run from the starting time segment or from the end time segment to the first time segment.

7. The method as claimed in claim 5, wherein determining the plurality of sequences of operating points comprising, for a first time segment in the sequence of time segments,
determining M subsequences of operating points running from a starting time segment or from an end time segment to a second time segment which adjoins the first time segment; and
determining, based on the operating points for the first time segment and on the M subsequences of operating points, extended subsequences of operating points which run from the starting time segment or from the end time segment to the first time segment.

8. The method as claimed in claim 6, further comprising the acts of:
determining M cumulative partial costs for the M subsequences of operating points;
determining, based on the operating points for the first time segment and on the M cumulative partial costs, cumulative partial costs for the extended subsequences of operating points; and
selecting a subset of the extended subsequences of operating points based on the cumulative partial costs for the extended subsequences of operating points.

9. The method as claimed in claim 7, further comprising the acts of:
determining M cumulative partial costs for the M subsequences of operating points;
determining, based on the operating points for the first time segment and on the M cumulative partial costs, cumulative partial costs for the extended subsequences of operating points; and
selecting a subset of the extended subsequences of operating points based on the cumulative partial costs for the extended subsequences of operating points.

10. The method as claimed in claim 8, further comprising the act of:
determining transition costs for a transition from an operating point in the second time segment to an operating point in the first time segment,
wherein the cumulative partial costs for the extended subsequences of operating points are also determined based on the transition costs, and wherein the transition costs depend on costs of changing the operating power.

11. The method as claimed in claim 9, further comprising the act of:
determining transition costs for a transition from an operating point in the second time segment to an operating point in the first time segment,
wherein the cumulative partial costs for the extended subsequences of operating points are also determined based on the transition costs, and
wherein the transition costs depend on costs of changing the operating power.

12. The method as claimed in claim 8, further comprising the acts of:
checking whether a first extended subsequence of operating points satisfies a secondary condition with respect to an amount of energy provided by the extended subsequence of operating points; and
rejecting the first extended subsequence of operating points if the secondary condition has not been satisfied.

13. The method as claimed in claim 10, further comprising the acts of:
checking whether a first extended subsequence of operating points satisfies a secondary condition with respect to an amount of energy provided by the extended subsequence of operating points; and
rejecting the first extended subsequence of operating points if the secondary condition has not been satisfied.

14. The method as claimed in claim 1, wherein the plurality of sequences of operating points are determined iteratively, time segment by time segment, starting from at least one of a starting time segment and an end time segment in the sequence of time segments.

15. The method as claimed in claim 1, wherein determining the limited number of possible operating powers comprises dividing an operating power interval into N possible operating powers,
wherein the operating power interval being limited by an operating power which can be received or delivered at most by the energy store, and
wherein N being less than or equal to 10, in particular.

16. The method as claimed in claim 1, wherein the power conditions comprise one or more of:
a maximum charging power which can be received by the energy store at a particular time,
a maximum discharging power which can be provided by the energy store at a particular time,
energy costs which arise at a particular time for charging and/or discharging the energy store,
a power which is requested by one or more electrical consumers and is predicted for a particular time, and
a locally generated power which is predicted for a particular time and can be provided by a local energy generation unit.
